(19) United States
(12) Patent Application Publication
(10) Pub. No.: US 2012/0266170 A1
(43) Pub. Date: Oct. 18, 2012

(54) Virtual Machine Image Management System and Methods

(76) Inventors: Roy William Zimmerman, Schnecksville, PA (US); Kenneth Michael Kapes, Allentown, PA (US)

(21) Appl. No.: 13/446,343

(22) Filed: Apr. 13, 2012

Related U.S. Application Data
(60) Provisional application No. 61/475,919, filed on Apr. 15, 2011.

(51) Int. Cl. G06F 9/455

(52) U.S. Cl. 718/1

(57) ABSTRACT

A computer-implemented method for managing virtual machine information in a cloud computing environment includes receiving, at a web server, an indication from a user to import an image of a virtual machine to a cloud in the cloud computing environment. The image may be uploaded to storage isolated to the user. At least one descriptor in the image may be parsed in a computer process to identify information (e.g., image meta-data) associated with an infrastructure service to be provided to the user. An infrastructure service item may be created in a computer process, corresponding to an instance of the infrastructure service. The service item is created based on the information identified by the parsing, e.g., by storing the image meta-data. The infrastructure service item may be inserted into an infrastructure service catalog of the user.

### PRIORITY CLAIM

This application claims priority under 35 U.S.C. §119(e) from U.S. Provisional Pat. Ser. No. 61/475,919 entitled “Virtual Machine Image Management System and Method” filed Apr. 15, 2011, the entirety of which is hereby incorporated by reference herein.

### BACKGROUND

Like the accelerated adoption of the Internet itself, cloud computing is rapidly gaining momentum. Cloud computing refers to a computing model for enabling on-demand network access to a shared pool of configurable information technology (IT) capabilities or resources (e.g., networks, servers, storage, applications, and services) that can be rapidly provisioned and released, e.g., with minimal management effort or service provider interaction. Cloud computing allows users to access technology-based services from a network cloud without knowledge of, expertise with, or control over the technology infrastructure that supports them, much as consumers of electric utilities are agnostic as to details of the underlying electrical grid. The cloud is a service provider's offering of abstracted computing-related services. The cloud computing model generally enables on-demand computing self-service, ubiquitous network access, location independent resource pooling, rapid elasticity (e.g., quick demand-based resource scaling), and measured computing service.

Service delivery models associated with cloud computing include the “Infrastructure as a Service” (IaaS), “Platform as a Service” (PaaS), and “Software as a Service” (SaaS) delivery models. In IaaS, computing infrastructure (e.g., a platform virtualization environment) is delivered as a service. Customers of IaaS purchase (or rent) computer infrastructure-related services as an outsourced service (e.g., on an as-needed or as-consumed basis) instead of having to purchase equipment (e.g., servers, software, data center space, or network equipment) themselves.

Enterprise access models (deployment models) associated with cloud computing include the public cloud, private cloud, community cloud, and hybrid cloud models. The multi-tenant IaaS cloud (public cloud) model provides infrastructure as a service to multiple customers and is typically based on providing various types of virtual machine (VM) operating systems (OS's) that customers can build to suit their particular needs. A VM refers to an instance of a server that includes with a virtual central processing unit (virtual CPU), virtual memory (e.g., virtual RAM), and virtual disk, including one or more guest operating systems. VMs are run on hardware systems that include computing, storage, and networking functionality.

Each bare VM typically provides a base OS with no applications. An individual customer installs and configures its desired OS, middleware, and/or applications on top of the base OS, thus making the VM useful to that customer. There has conventionally been no mechanism to move VMs into and out of a public cloud. In addition, the VMs that are built have conventionally been dependent on a specific hypervisor technology, e.g., VMware®, Hyper-V™, KVM (kernel-based virtual machine), etc. A hypervisor (or virtual machine monitor, “VMM”) refers to a virtualization approach in which a virtual OS is presented to guest operating systems that run concurrently on a host computer, and execution of the guest operating systems is monitored by the hypervisor.

The lack of portability of VMs between cloud environments presents significant obstacles for conventional cloud computing approaches. For example, once a customer moves its applications into a public cloud of a particular service provider, the customer is confined to that service provider's cloud unless the customer rebuilds from the start (i.e., from a clean slate) on some other provider's public cloud, which is a time consuming exercise that essentially defeats the entire point of a cloud environment.

### SUMMARY

In some embodiments of the present disclosure, a computer-implemented method for managing virtual machine information in a cloud computing environment includes receiving, at a web server, an indication from a user to import an image of a virtual machine to a cloud in the cloud computing environment. The image may be uploaded to storage isolated to the user. At least one descriptor in the image may be parsed in a computer process to identify information (e.g., image meta-data) associated with an infrastructure service to be provided to the user. An infrastructure service item may be created in a computer process, corresponding to an instance of the infrastructure service. The service item is created based on the information identified by the parsing, e.g., by storing the image meta-data. The infrastructure service item may be inserted into an infrastructure service catalog of the user.

In some embodiments of the present disclosure, a computer-implemented method for managing virtual machine (VM) information in a cloud computing environment includes receiving, at a web server, an indication from a user to export an image of a virtual machine from a cloud in the cloud computing environment. At storage dedicated for image management, an image of a virtual machine corresponding to a selected infrastructure service item may be created. The created image may be sent to the user. The image may be deleted from storage, and the selected service item may be removed from the user's infrastructure service catalog.

In some embodiments of the present disclosure, a virtual machine image management system includes multiple service cores, a web server, a transport layer server, a storage unit, a provisioning controller, a virtualization manager, and an application server. The service cores may be configured to provide processing, storage, and networking in a cloud in a cloud computing environment. The web server may be configured to receive an indication from a user to import an image of a virtual machine to the cloud. The transport layer server may be configured to upload the image. The storage unit may be isolated to the user (e.g., isolated from other users) and configured to store the uploaded image. The provisioning controller may be configured to identify one of the service cores to provide an infrastructure service to be provided to the user. The virtualization manager may be configured to parse at least one descriptor in the image automatically to identify information associated with an infrastructure service to be provided to the user. The application server may be configured to create an infrastructure service item corresponding to an instance of the infrastructure service automatically based on the output from parsing at least one descriptor. The application server may be further configured to insert the infrastructure service item into an infrastructure service catalog of the user. The web server may be further configured to display the catalog to the user.

In some embodiments of the present disclosure, a virtual machine image management system includes multiple service cores, a storage unit, a web server, a transport layer server, a virtualization manager, and a provisioning controller. The service cores may be configured to provide processing, storage, and networking in a cloud in a cloud computing environment. The storage unit may be isolated to the user (e.g., isolated from other users) and configured to store a plurality of VM images. The web server may be configured to receive an indication from a user to export an image of a selected virtual machine from the cloud, and further configured to select an infrastructure service item from an infrastructure service catalog of the user based on the received indication. The transport layer server may be configured to send the image to the user. The virtualization manager may be configured to create, at the storage unit, an image of a virtual machine corresponding to the selected service item. The provisioning controller may be configured to identify one of the service cores to provide an infrastructure service to be provided to the user. The web server may be further configured to display the catalog to the user. The virtualization manager may be further configured to delete the image after the image is sent to the user, and remove the selected service item from the service catalog.

In some embodiments of the present disclosure, a virtual machine (VM) image management system includes multiple service cores, a user interface module, an automation module, a data module, and a monitoring/management module. The service cores may be configured to provide processing, storage, and networking capabilities. Each service core may include at least one processor, at least one storage unit, and at least one networking switch. The user interface module may be configured to provide multiple portals and multiple service catalogs for respective users of a cloud in a cloud computing environment. The automation module may be configured to automatically manage provisioning operations, import a first image of a first virtual machine from one of the users to the cloud automatically, and export a second image of a second virtual machine from the cloud to one of the users automatically. The data module may be configured to store organization-specific information associated with each user and infrastructure configuration information associated with the service cores. The monitoring/management module may be configured to provide an interface between operational personnel of a service provider and the cloud.

### BRIEF DESCRIPTION OF THE DRAWINGS

The following will be apparent from elements of the figures, which are provided for illustrative purposes and are not necessarily to scale.

FIG. 1 is a block diagram of a cloud management platform in accordance with some embodiments of the present disclosure.

FIG. 2 is a diagram of a service core for a cloud in a cloud computing environment in accordance with some embodiments.

FIG. 3 is a block diagram of a virtual machine (VM) image management system in accordance with some embodiments.

FIG. 4 is a block diagram of a virtual machine (VM) image management system in accordance with some embodiments.

FIG. 5 is a flow diagram for provisioning a VM in accordance with some embodiments.

FIG. 6 is a flow diagram for importing a VM image into a cloud in accordance with some embodiments.

FIG. 7 is a flow diagram for exporting a VM image out of a cloud in accordance with some embodiments.

### DETAILED DESCRIPTION

This description of the exemplary embodiments is intended to be read in connection with the accompanying drawings, which are to be considered part of the entire written description.

Various embodiments address the foregoing deficiencies of prior art cloud computing approaches and provide virtual machine (VM) image management to facilitate flexible, portable VM-related resource management to the benefit of customers and service providers alike. For example, customers benefit from being able to use cloud computing more reliably in a variety of different contexts, and providers benefit from resulting increased customer usage.

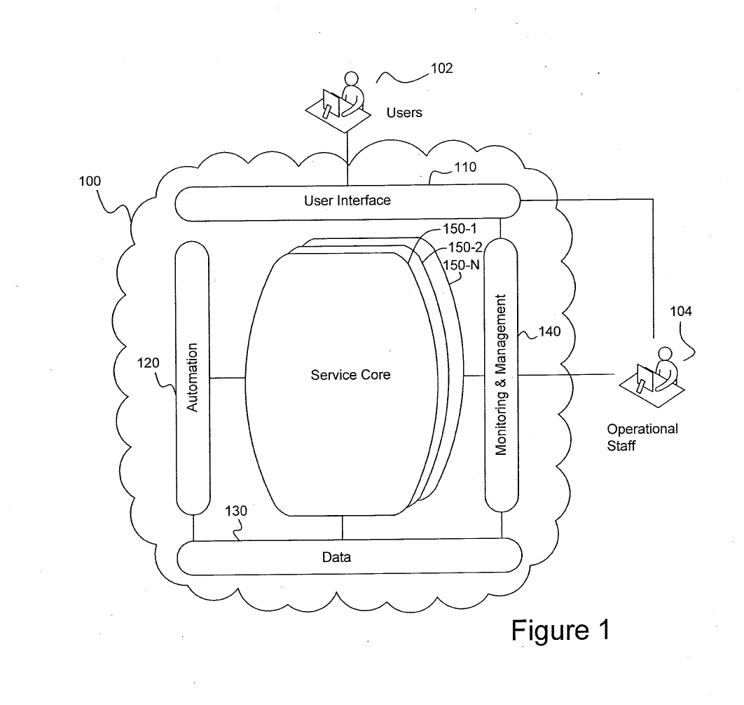

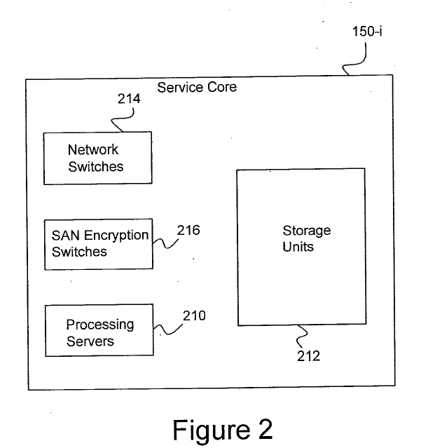

Some embodiments of the present disclosure provide an Infrastructure as a Service (IaaS) multi-tenant cloud 100 as shown in FIG. 1 that includes multiple blocks of hardware, referred to as service cores (denoted service cores 150-1, 150-2, . . . , 150-N; these may be referred to collectively as “service cores 150”) and various modules including a user interface 110, and automation, data, and monitoring/management modules 120, 130, and 140, respectively, that provide self-service provisioning of VM resources. Although three service cores are shown in this example, any number of service cores may be used. Operational personnel 104 (e.g., system administrators or other personnel of a service provider) access the monitoring/management module 104 (referred to as management module 104 for convenience) and/or the user interface 110. FIG. 2 shows an example service core 150-i that includes one or more servers 210 (e.g., blade servers), one or more storage units 212 (e.g., providing multi-tiered storage with encryption), and one or more network switches, including network switch 214 and/or encryption switch 216. These components of service core 150-i may be configured as is known in the art.

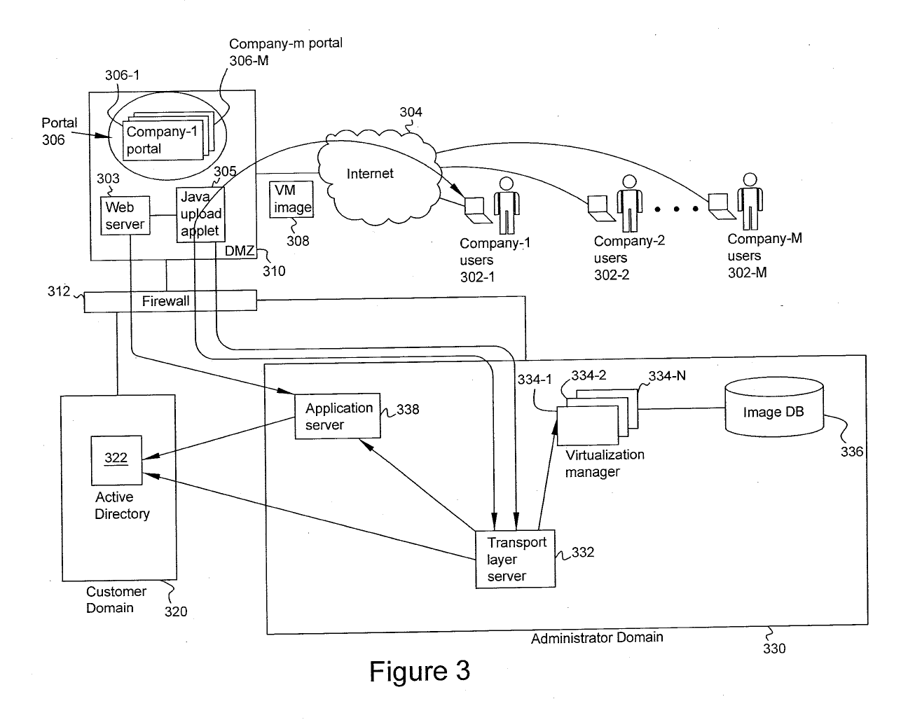

Referring again to FIG. 1, the user interface module 110 provides an interface between users 102 and the cloud 100 (e.g., a public cloud) for self-service. The user in this context may refer to a customer of the cloud provided by a cloud service provider or an individual at a customer site. The user interface module 110 may include a portal 306 (referring now to FIG. 3), including a separate portal and a separate service catalog for each customer (e.g., for each of several organizations). A service catalog is a database or structured document with information about various services offered to a customer, including services available for deployment, such as provisioning a virtual machine. Users in one organization may be segregated from users in other organizations. Portals 306-1, . . . , 306-M are shown in FIG. 3 for providing access to users 302-1, 302-2, . . . , 302-M of respective companies COMPANY-1, COMPANY-2, . . . , COMPANY-M. Users are referred to generically as users 302. Although the breakdown is by companies in this example, portals may be used for providing access to users in other segregational or classification schemes.

The automation module 120 manages provisioning operations, including determining the appropriate service core to which to provision a VM and determining which infrastructure components to use and the quantity of resources to use for the VM. The automation module 120 also synchronizes configuration item information within the data module 130 and the user interface module 110. The data module 130 includes organization-specific information and infrastructure configuration information.

Various embodiments of the present disclosure provide the capability to transport VMs into and out of the cloud 100 (e.g., multi-tenant cloud 100) and between hypervisor technologies. A customer may import and export VM information using a VM image, which is a software representation, embodied in a tangible computer-readable medium, of an implementation of one or more VMs and of any software to be run therein. In some embodiments, customers may import and export VM information using VM images that are hypervisor-independent, i.e., not tied to any particular hypervisor technology or architecture, which advantageously provides flexibility to customers. For example, VM images conforming to the industry's Open Virtualization File (OVF) standard (referred to variously as OVF images, OVF VM images, OVF packages, or OVF appliances) may be used.

In various embodiments, all VM provisioning is performed within the cloud using VM images (e.g., OVF VM images), which may include provisioning from one or more images provided by a service provider or from images that the customer uploads, creates from start (i.e., a “clean slate” creation where the customer builds up all the VM information), or copies from other VMs. In some embodiments, since all images are based on a hypervisor-independent format, the images may be used to provision VMs on different hypervisor technologies. The images include not only the OS for the represented VMs but all middleware and applications that the customer has installed and configured.

In the OVF format, each VM image includes at least two files: (1) a descriptor, which may include a file in an extensible format such as XML that includes metadata for the OVF image and includes links to external files, such as virtual disks; and (2) a virtual machine disk (VMDK) format specification that describes and documents the VM environment and how it is stored (i.e., a set of virtual disks). Optionally, a VM image may also include a manifest file, which includes an authentication digest for various files in the VM image, and a certificate file, which includes digital signature information to ensure data integrity.

Using VM images, a VM image management system provides the ability for customers to: upload and download their own VM images as part of import and export processes, respectively; use a provided base VM image; and copy VMs that have been built in a service provider's cloud to a VM image. In some embodiments, all VM images are added as service items to the customer's service catalog, which allows the customer to provision VMs using any image in its catalog. A service item includes data about an instance of a service (e.g., IaaS service) that a user may access via a service catalog or database in which the service item appears as an entry. All of a customer's images may be downloaded out of the cloud in an export process.

As illustrated in FIG. 3, users 302 (e.g., users at a customer site) may upload or download VM image(s) 308 via their corresponding company portal 306 located in a demilitarized zone (DMZ) 310. The users may access the portal through a network 304 such as the Internet. A web server 303 and an applet 305 (e.g., an applet for uploading, which may be implemented with Java code) provide portal functionality such as presenting a web interface to the users 302. Users 302 login and are authenticated to their corresponding company portal 306, which segregates them from users in other organizations (i.e., other customers) or from other users in the same organization. Once authenticated, when a user chooses to upload or download a VM image 308, the portal 306 performs a handshake with a transport layer server 332, e.g., a file transfer protocol (FTP) server. A firewall 312 may be used for increased security. The transport layer server 332 may be located in an administrative domain 330 of the cloud and may present the user with a file transfer interface. During that handshake process, the user is authenticated, her home directory 322 in the customer domain 320 is determined, and she is homed to her directory.

For an import of a VM image, once the image is uploaded (using the transport layer, for example), the image may be validated at one of the virtualization managers 334-1, . . . , 334-N associated with a respective service core. Validation is performed, e.g., using a standard command, to ensure that the image is a valid image that does not contain any errors resulting from the uploading. If the image is valid and thus suitable for subsequent processing, the descriptor file of the image may be parsed at the corresponding virtualization manager to obtain metadata information relevant to providing a VM (whose implementation is represented by the VM image) in the user's service catalog. For example, the VM image may include information pertaining to the network configuration of a network in which a VM originated. The virtualization manager may be coupled to a corresponding image database 336 that stores various service core images. In some embodiments, there are multiple image databases, with one image database 336-i corresponding to each virtualization manager 334-i, although only one image database is depicted in FIG. 3 for graphical convenience.

The parsed descriptor information is passed from transport layer server 332 to an application server 338 and may be used to create a new service item at the application server. The service item may be inserted by the application server 338 as an entry into the user's service catalog, and the catalog entry may be made available for provisioning at the virtualization manager. The VM image may be placed on storage that is located on the physical hardware where the provisioning operations are performed, thus providing high performance provisioning. Each unit within a customer organization (e.g., department within a company) may have its own VM image folder and its own service catalog.

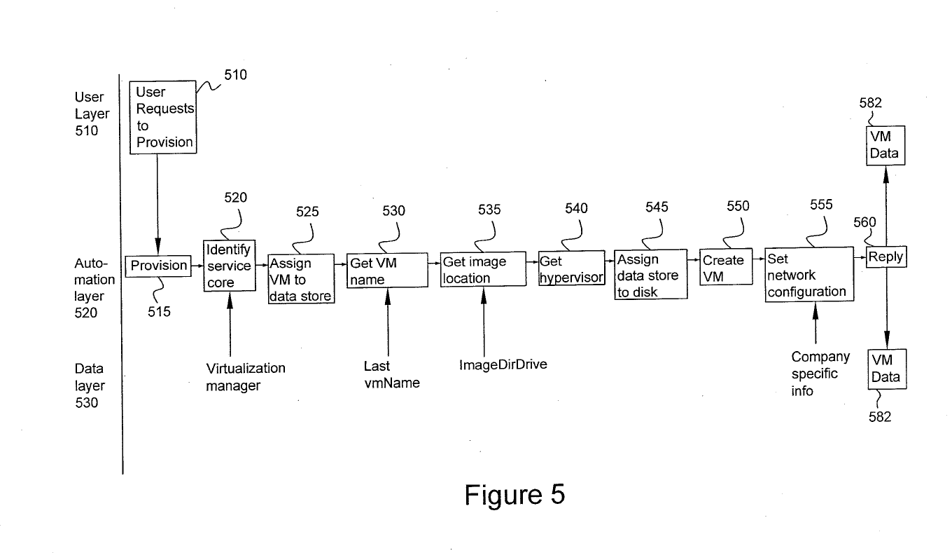

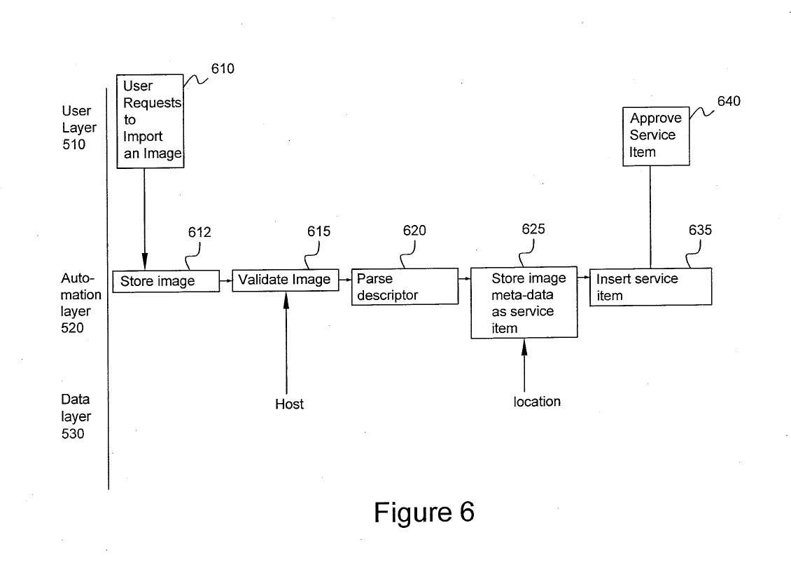

FIG. 6 shows interactions related to importing a VM image that occur between layers corresponding to various modules of FIG. 1. The user layer 510, automation layer 520, and data layer 530 shown in FIGS. 5-7 correspond to functionality at the user interface module 110, automation module 120, and data 130 module of FIG. 1, respectively. Referring to FIG. 6, at the user layer 510, a user requests to import a VM image (block 610) to a cloud. The image is uploaded to storage isolated to the user, and validated (block 615). The image is validated against a hypervisor, using information from the data layer 530, to ensure hardware compatibility. At block 620, one or more descriptors in the image are validated to identify information associated with an infrastructure service to be provided to the user. At block 625, image meta-data is stored to disk of a service core as a service item in the user's service catalog, e.g., based on location information provided by the data layer 530. A service item is created (block 630) and inserted into a user's service catalog (block 635). Using the interface module 110, the user may approve the service item (block 640).

Thus, unlike conventional cloud computing approaches, embodiments of the present disclosure provide the ability to create a service item from a VM image that a user imports, e.g., from a VM image that has been previously modified or manipulated. The service item may be accessed by a user 302 at the web server 303 that implements the portal.

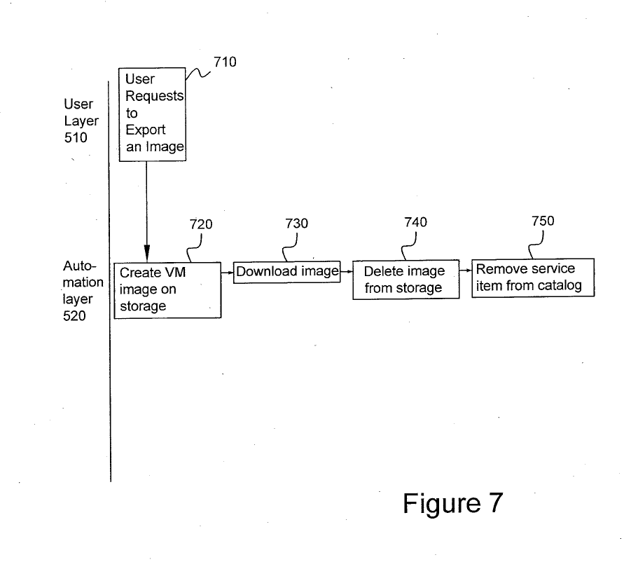

FIG. 7 shows interactions related to exporting a VM image that occur between the user layer 510 and automation layer 520. At the user layer 510, a user 302 requests to export a VM image from a cloud (block 710). At the time of the request, the image does not exist yet, but the VM exists and corresponds to an infrastructure service item selected by the user. A VM image (e.g., OVF package) is created in the user's storage area (block 720). The user 302 is connected to a download server (e.g., transport layer server 332) and downloads the newly created VM image to her local machine (block 730). The image is deleted from the user's storage area (block 740) by a virtualization manager 334. The service item corresponding to the image is removed from the user's service catalog (block 750) by the virtualization manager.

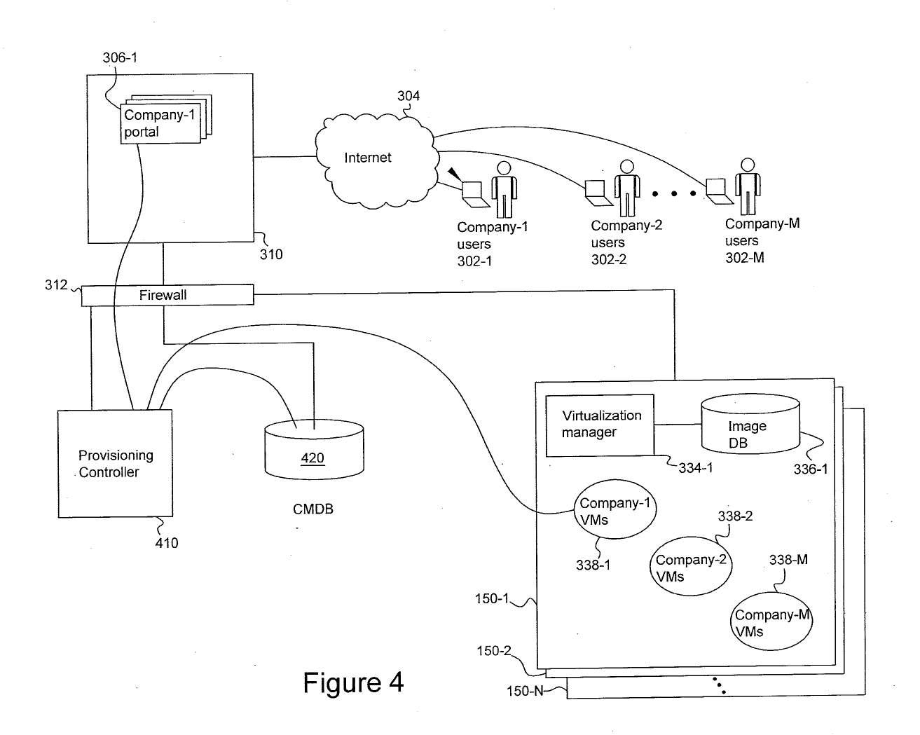

As illustrated in FIG. 4, image management is the basis for provisioning in the cloud. A user selects a VM image from her service catalog and specifies how to provision that service. The service may correspond to one or more VMs. Once the service has been specified, the user requests to have the service provisioned. A provisioning task request is made from the portal shown in FIG. 4 (e.g., web server in FIG. 3) to a provisioning controller. The provisioning controller 410, CMDB 420, and service cores 150 may be part of the administrative domain 330. The provisioning controller 410 provides logic that determines a service core (among service cores 150-1, 150-2, . . . , 150-N shown in FIG. 4) to which to provision the VM image. As shown in FIG. 4, for each service core, the corresponding virtualization manager is coupled to a corresponding image database 336-i where VM images reside. The virtualization manager 334-1 handles virtualization tasks for VMs of various customers, e.g., VMs 338-1, . . . , 338-M of respective companies COMPANY-1, COMPANY-M.

Once the provisioning controller 410 identifies where to carry out the provisioning operation, it instructs the corresponding virtualization manager of the identified service core how to provision and which images to use to perform provisioning operations. All provisioning operations are entered into a configuration management database (CMDB) 420, and the provisioning controller 410 sends information back to the application server 338 (refer to FIG. 3) that the application server then uses to create service items corresponding to provisioned configuration items. In some embodiments, provisioning operations may be implemented with Java code using the VMware VI Java API.

Referring to FIG. 5, provisioning of a VM from a VM image may be implemented by interactions between the user layer 510, automation layer 520, and data layer 530. At the user layer 510, a user requests to provision a VM image to a VM (block 510). The automation layer 520, which may include the provisioning controller 410, initiates provisioning of a VM (block 515). At block 520, the automation layer 520 determines the appropriate service core in which to create the VM (i.e., the service core to which to provision an image), based on input from a virtualization manager. At block 525, a virtual machine is assigned to a data store, which is the persistent area on storage for the virtual machine operating system. At block 530, the automation layer 520 gets a name for the virtual machine from the data layer 530. At block 535, an image location is retrieved at the automation layer 520 based on information from the image database 336 at the data layer 530. At block 540, a hypervisor host is selected to be assigned to the virtual machine. At block 545, a data store is assigned to the data disk for the virtual machine At block 550, a virtual machine is created. At block 555, network configuration is set at the automation layer 520, e.g., based on company-specific information from the data layer 530. At block 560, a reply is generated, including sending data 582 about the provisioned virtual machine to the user layer 510 (for communicating information about the provisioned VM to the user) and the data layer 530.

Importing of one or more VM images may be followed by exporting. For example, some embodiments provide the ability to import a VM image from a user to the cloud, modify the image, and export the modified image back to the user. The portability and flexibility thus provided has not been available with conventional cloud computing systems.

Although examples are illustrated and described herein, embodiments are nevertheless not limited to the details shown, since various modifications and structural changes may be made therein by those of ordinary skill within the scope and range of equivalents of the claims.

What is claimed is:

1. A computer-implemented method for managing virtual machine information in a cloud computing environment, the method comprising:
receiving, at a web server, an indication from a user to import an image of a virtual machine to a cloud in the cloud computing environment;
uploading the image to storage isolated to the user;
parsing at least one descriptor in the image in a computer process to identify information associated with an infrastructure service to be provided to the user;
creating an infrastructure service item corresponding to an instance of the infrastructure service in a computer process based on the information identified by the parsing; and
inserting the infrastructure service item into an infrastructure service catalog of the user.

2. The method of claim 1, further including validating the uploaded image automatically;
wherein the parsing is performed only if the image is determined to be a valid image.

3. The method of claim 1, further including provisioning a virtual machine at a service core based on the image

4. The method of claim 1, wherein the cloud is a public cloud.

5. The method of claim 4, wherein the cloud is a multi-tenant public cloud.

6. The method of claim 1, wherein the image is a hypervisor-independent image.

7. The method of claim 6, wherein the image is an open virtualization format (OVF) image.

8. A computer-implemented method for managing virtual machine (VM) information in a cloud computing environment, the method comprising:
receiving, at a web server, an indication from a user to export an image of a virtual machine from a cloud in the cloud computing environment;
creating, at storage dedicated for image management, the image of a virtual machine corresponding to a selected infrastructure service item;
sending the created image to the user;
deleting the image from storage; and
removing the selected service item from an infrastructure service catalog of the user.

9. The method of claim 8, wherein the cloud is a public cloud.

10. The method of claim 9, wherein the cloud is a multi-tenant public cloud.

11. The method of claim 8, wherein the image is a hypervisor-independent image.

12. The method of claim 11, wherein the image is an open virtualization format (OVF) image.

13. A virtual machine image management system comprising:
a plurality of service cores configured to provide processing, storage, and networking in a cloud in a cloud computing environment;
a web server configured to receive an indication from a user to import an image of a virtual machine to the cloud;
a transport layer server configured to upload the image;
a storage unit isolated to the user, wherein the storage unit is configured to store the uploaded image;
a provisioning controller configured to identify one of the service cores to provide an infrastructure service to be provided to the user;
a virtualization manager configured to parse at least one descriptor in the image automatically to identify information associated with an infrastructure service to be provided to the user; and.
an application server configured to create an infrastructure service item corresponding to an instance of the infrastructure service automatically based on the parsed output of at least one descriptor, said application server further configured to insert the infrastructure service item into an infrastructure service catalog of the user;
wherein the web server is further configured to display the catalog to the user.

14. The virtual machine image management system of claim 13, wherein the cloud is a multi-tenant public cloud.

15. A virtual machine (VM) image management system comprising:
a plurality of service cores configured to provide processing, storage, and networking in a cloud in a cloud computing environment;
a storage unit isolated to the user, wherein the storage unit is configured to store a plurality of VM images;
a web server configured to:
receive an indication from a user to export an image of a selected virtual machine from the cloud, and
select an infrastructure service item from an infrastructure service catalog of the user based on the received indication;
a virtualization manager configured to create, at the storage unit, an image of a virtual machine corresponding to the selected service item;
a transport layer server configured to send the created image to the user; and
a provisioning controller configured to identify one of the service cores to provide an infrastructure service to the user;
wherein the web server is further configured to display the catalog to the user, and the virtualization manager is further configured to delete the image after the image is sent to the user, and remove the selected service item from the service catalog.

16. The VM image management system of claim 15, wherein the cloud is a multi-tenant public cloud.

17. A virtual machine (VM) image management system comprising:
a plurality of service cores configured to provide processing, storage, and networking capabilities, each service core comprising at least one processor, at least one storage unit, and at least one networking switch;
a user interface module configured to provide a plurality of portals and a plurality of service catalogs for respective users of a cloud in a cloud computing environment;
an automation module configured to automatically manage provisioning operations, import a first image of a first virtual machine from one of the users to the cloud automatically, and export a second image of a second virtual machine from the cloud to one of the users automatically;
a data module configured to store organization-specific information associated with each user and infrastructure configuration information associated with the service cores; and
a monitoring and management module configured to provide an interface between operational personnel of a service provider and the cloud.

18. The VM image management system of claim 17, wherein the first virtual machine is the second virtual machine.

19. The VM image management system of claim 17, wherein the cloud is a multi-tenant public cloud.

20. The VM image management system of claim 17, wherein the first and second images are hypervisor-independent images.
